(19) United States
(12) Patent Application Publication
(10) Pub. No.: US 2023/0405685 A1
(43) Pub. Date: Dec. 21, 2023

(54) ROTARY CUTTING TOOL AND METHOD FOR MANUFACTURING

(71) Applicant: KENNAMETAL INC., Latrobe, PA (US)

(72) Inventors: Eduard Ach, Vohenstrauss (DE); Horst Jaeger, Fuerth (DE); Patrick Kuhlemann, Fuerth (DE)

(21) Appl. No.: 18/211,365

(22) Filed: Jun. 19, 2023

(30) Foreign Application Priority Data
Jun. 21, 2022 (DE) 102022115408.4

(51) Int. Cl. B23B 27/10; B23P 15/34

(52) U.S. Cl. CPC B23B 27/10; B23P 15/34

(57) ABSTRACT

A rotary cutting tool (10) has an axis of rotation (R) and a tool body (12) extending along the axis of rotation (R) and having at least one coolant channel (30). At least a portion (32) of the at least one coolant channel (30) is formed by a groove (40) in a circumferential face (42) of the tool body (12). Furthermore, the at least one coolant channel (30) in the portion (32) of the groove (40) is closed in the radial direction by an add-on part of the rotary cutting tool (10) attached to the tool body (12). Furthermore, a method for manufacturing such a rotary cutting tool (10) is provided.

### RELATED APPLICATION DATA

The present application claims priority under 35 U.S.C. § 119 to German Patent Application No. 102022115408.4, filed on Jun. 21, 2022, the disclosure of which is incorporated by reference herein in its entirety.

### FIELD

The invention relates to a rotary cutting tool having an axis of rotation and a tool body extending along the axis of rotation and having at least one coolant channel. Furthermore, the invention relates to a method for manufacturing such a rotary cutting tool.

### BACKGROUND

Rotary cutting tools with coolant channels as well as their manufacture are known.

The coolant channels are typically drilled in the axial direction into the tool body, which is then plastically deformed into the final shape, for example spirally twisted.

It is disadvantageous in these rotary cutting tools that the cost of manufacture is very high, in particular in the case of axially very long rotary cutting tools, in which correspondingly long coolant channels must be drilled, or in the case of rotary cutting tools having a large diameter, which can only be plastically deformed with great effort.

The problem addressed by the invention is to provide a rotary cutting tool having at least one coolant channel that can be manufactured with low effort. A further problem addressed by the invention is to provide a method for manufacturing such a rotary cutting tool.

### SUMMARY

The problem is solved by a rotary cutting tool having an axis of rotation and a tool body extending along the axis of rotation and having at least one coolant channel. At least a portion of the at least one coolant channel is formed by a groove in a circumferential face of the tool body. Furthermore, the at least one coolant channel in the portion of the groove is closed in the radial direction by an add-on part of the rotary cutting tool attached to the tool body, in particular rigidly.

According to the present invention, it has been found that, in this way, a rotary cutting tool with an inner coolant channel can be manufactured with low effort. In particular, in comparison to the prior art, in which the coolant channels are typically drilled in the axial direction, in the rotary cutting tool according to the invention, the coolant channel can be introduced circumferentially into the tool body from radially outwards at least in the portion of the groove, which is associated with significantly less effort particularly in the case of axially long rotary cutting tools. Due to the fact that the radially outwardly open portion of the coolant channel, i.e., the portion with the groove, is closed by the add-on part, in particularly sealingly, it is ensured that coolant can be reliably directed through the coolant channel to the cutting region during the cutting operation.

In one embodiment, the at least one coolant channel is arranged in a fluted portion of the tool body having at least one flute. Thus, chips that are removed from the workpiece during the cutting operation can be effectively disposed of.

In this case, the at least one coolant channel and the at least one flute can extend helically in the axial direction. Through the portion with the groove, the rotary cutting tool can be manufactured inexpensively even when the tool body has a large diameter. In particular, when the portion is arranged with the groove in the helical portion, the rotary cutting tool can be manufactured without the need to twist the rotary cutting tool.

Furthermore, it can be provided that the groove has a cross-section with at least one straight segment. This means that the cross-section is not round, in particular not circularly round, like the cross-section of a drill hole. This design allows the groove to be manufactured with particularly low effort.

According to one embodiment, the add-on part is formed by a tube attached in the at least one coolant channel. In this way, the portion with the groove can be reliably closed with low effort.

In particular, the tube is configured such that, during the cutting operation of the rotary tool, coolant is directed or flows through the interior of the tube. In other words, the tube forms a coolant line.

Furthermore, the tube can radially abut or extend beyond the circumferential face of the tool body in order to form an abutment face via which the rotary cutting tool can abut the workpiece during the cutting operation, for example, the drillhole wall. Depending on the material of the tube and the overhang selected, a rotary cutting tool with particularly favorable guiding and/or sliding properties can thus be provided.

Additionally or alternatively, the tube can comprise a tube wall with an opening that fluidly connects the interior of the tube laterally to a second coolant channel of the rotary cutting tool, in particular wherein the second coolant channel is formed in a portion axially opposite a shaft-side portion of the rotary cutting tool. In this way, a branch can be provided with low effort that extends laterally from the tube in order to direct coolant through the second coolant channel during the cutting operation.

According to a further embodiment, the add-on part is formed by a weld seam, which can be manufactured with particularly low effort and reliably closes the portion with the groove.

According to the invention, in order to solve the aforementioned problem, a method for manufacturing a rotary cutting tool according to the invention with the aforementioned advantages is also provided. The method comprises the steps of:
a) manufacturing the at least one coolant channel by means of machining, and
b) attaching the add-on part.

The groove of the at least one coolant channel can be formed in the circumferential face of the tool body in the radial direction, whereby the coolant channel can be manufactured with particularly low effort.

### BRIEF DESCRIPTION OF THE DRAWINGS

Further advantages and features will emerge from the following description and from the accompanying drawings. The figures show:

FIG. 1 in a perspective view, a rotary cutting tool according to the invention without add-on parts,

FIG. 2 in a lateral view, the rotary cutting tool of FIG. 1 without add-on parts, wherein hidden edges are shown by a dashed line,

FIG. 3 in a lateral view, the rotary cutting tool of FIG. 1 with add-on parts,

FIG. 4 the rotary cutting tool in a sectional view along the plane A-A in FIG. 3,

FIG. 5 in a perspective view, a rotary cutting tool according to the invention without add-on parts according to a further embodiment,

FIG. 6 in a lateral view, the rotary cutting tool of FIG. 5 without add-on parts, wherein hidden edges are shown by a dashed line,

FIG. 7 in a lateral view, the rotary cutting tool of FIG. 5 with add-on parts, and

FIG. 8 the rotary cutting tool in a sectional view along the plane A-A in FIG. 7.

### DETAILED DESCRIPTION

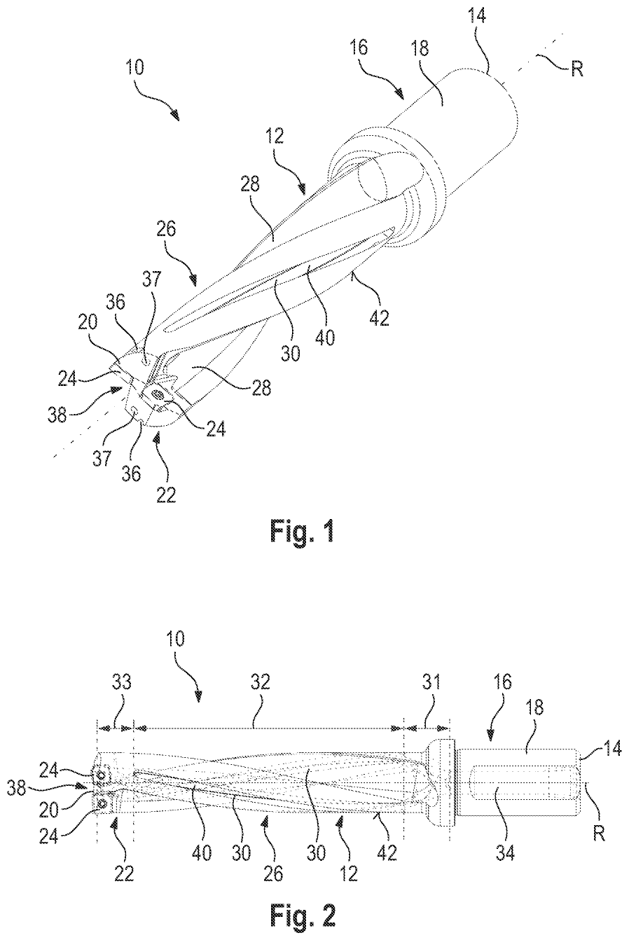

In FIG. 1, a rotary cutting tool 10 is shown having a tool body 12 extending along a longitudinal central axis defining an axis of rotation R of the rotary cutting tool 10.

The rotary cutting tool 10 is provided for carrying out cutting operations on a workpiece (not shown) when the rotary cutting tool 10 is rotated about the axis of rotation R.

The rotary cutting tool 10 has, at an axial end 14, a shaft-side portion 16 with a shaft 18, by means of which the rotary cutting tool 10 can be attached in a toolholder, such as a chuck mechanism.

At the opposite axial end 20, the rotary cutting tool 10 has a cutting portion 22, by means of which the workpiece is machined during the cutting operation.

In the illustrated embodiment, the rotary cutting tool 10 is an indexing drill and the cutting portion 22 is accordingly configured with pocket-like toolholders in which exchangeable cutting inserts 24 are attached.

In an alternative embodiment, the rotary cutting tool 10 can be any rotary cutting tool, particularly any drill or mill.

Furthermore, the rotary cutting tool 10 can be integral or modular.

The tool body 12 has a fluted portion 26 with two flutes 28 that extend in a helical manner from the opposite axial end 20 to the shaft 18.

Furthermore, the tool body 12 comprises two inner coolant channels 30 (see FIG. 2) extending in a helical manner from the cutting portion 22 to the shaft 18.

In principle, the tool body 12 can be designed as desired, as long as it comprises at least one coolant channel 30.

In particular, in an alternative embodiment, the tool body 12 may not have a flute 28 or any number of flutes 28.

Additionally or alternatively, the flutes 28 and the coolant channels 30 can extend at any helical angle opposite the axis of rotation R, particularly at an angle of 0°, i.e., the flutes 28 and coolant channels 30 run parallel to the axis of rotation R, and thus not helically.

The coolant channels 30 are designed so as to be substantially identical. Thus, the design of the coolant channels 30 will be explained below using a coolant channel 30 by way of example.

The coolant channel 30 has a first axial portion 31, a second axial portion 32, and a third axial portion 33.

The first axial portion 31 extends from a coolant terminal 34 in the shaft 18 to the second axial portion 32, while the third axial portion 33 extends opposite the first axial portion 31 from the second axial portion 32 through the cutting portion 22 and opens into the cutting region 38 via openings 36, 37, in which region the workpiece is machined during the cutting operation.

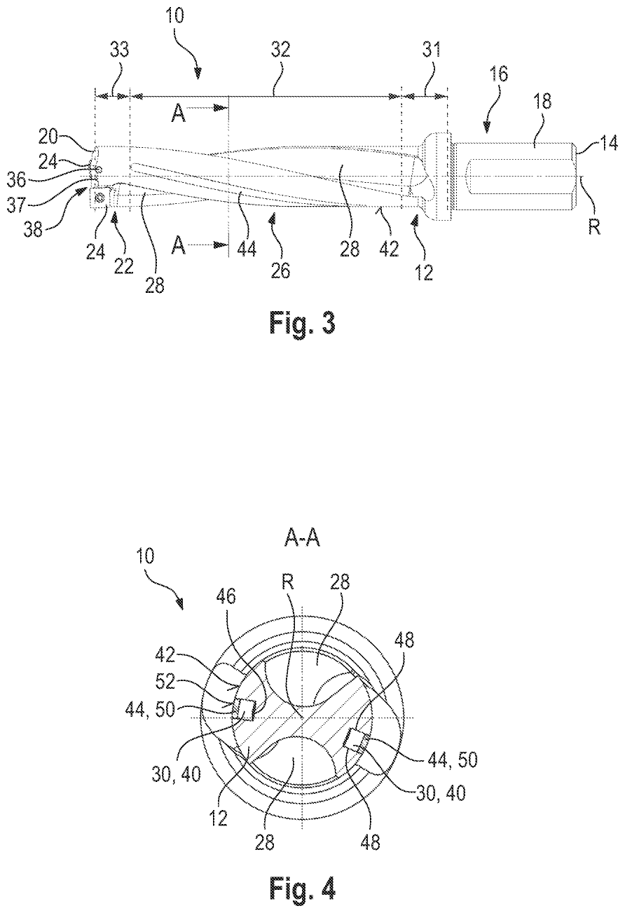

The second axial portion 32 extends through a groove 40 (see FIG. 4) in the circumferential face 42 of the tool body 12, which is closed outwardly by an add-on part 44 (see FIG. 3).

The groove 40 has a rectangular cross-section defined by a straight floor segment 46 as well as two straight wall segments 48.

The add-on part 44 here is a weld seam 50, which closes the groove 40 in the form of a lid completely and sealingly against the surrounding environment.

In principle, the groove 40 can have any cross-section.

Furthermore, in an alternative embodiment, the first axial portion 31 and/or the third axial portion 33 can be formed at least in portions by a groove 40, which is accordingly closed with an add-on part 44.

During the cutting operation, the coolant channel 30 can be fluidly connected to a pressurized coolant source via the coolant terminal 34 in order to direct coolant through the coolant terminal 34 via the coolant channel 30 and through the openings 36, 37 into the cutting region 38.

To manufacture the rotary cutting tool 10, the groove 40 is milled from radially outward into the circumferential face 42 of the tool body 12 in order to form the second axial portions 32 of the coolant channels 30.

The first axial portions 31 and the third axial portions 33 of the coolant channels 30 are drilled.

In principle, the axial portions 31, 32, 33 can be formed in any way by means of milling.

In a further step, the groove 40 is closed radially outwardly in the circumferential direction by welding with the weld seam 50.

In a subsequent step, the weld seam 50 can be processed, for example, machined, in particular in order to make the radial exterior 52 of the weld seam 50 level with the circumferential face 42.

The remaining features of the rotary cutting tool 10, in particular the flutes 28, can be formed at any given time.

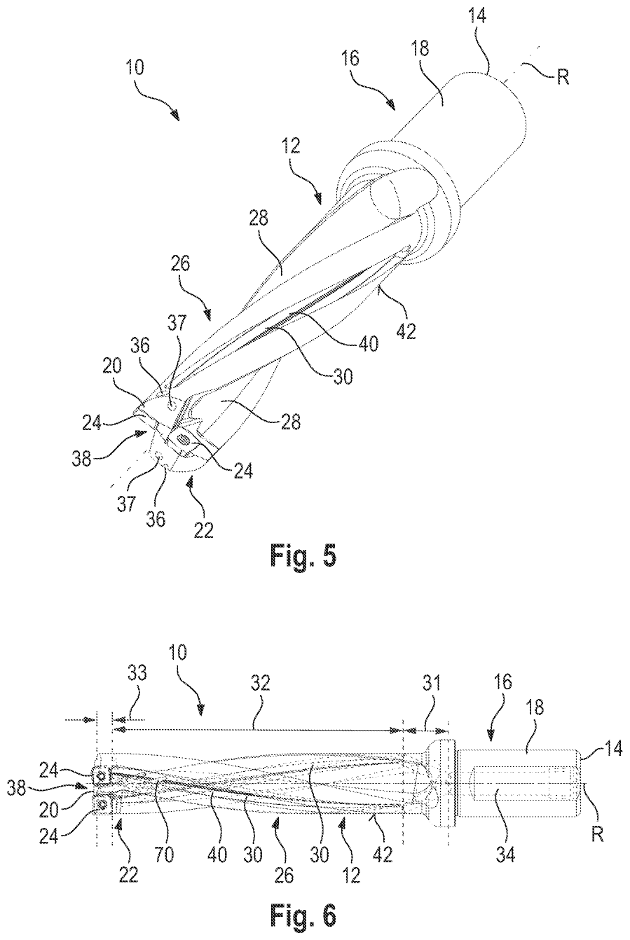

A rotary cutting tool 10 according to a further embodiment will now be described based on FIGS. 5 through 8. For the components known from the above embodiment, the same reference numerals are used, and reference is made in this respect to the foregoing explanations.

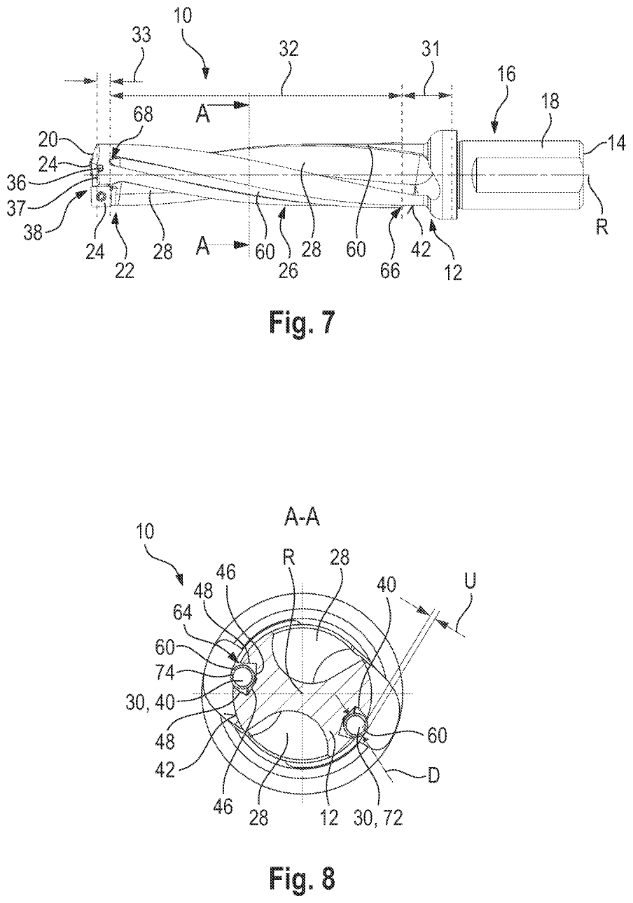

By contrast to the embodiment shown in FIGS. 1 to 4, in the embodiment of the rotary cutting tool 10 shown in FIGS. 5 to 8, the add-on part 44 is not a weld seam 50 but rather a tube 60 (see FIG. 7) that is attached in the groove 40.

The tube 60 is made of metal, for example stainless steel.

In the present embodiment, the tube 60 is positively attached in the groove 40.

For this purpose, the wall segments 48 (see FIG. 8) are aligned radially towards the circumferential face 42 at an angle to one another, such that the groove 40 forms a gap 64 on the circumferential face 42, said gap being narrower than the outer diameter D of the tube 60.

In this context, the groove 40 has two floor segments 46 that abut one another at an angle of less than 180°.

In principle, the groove 40 can have any cross-section.

Additionally or alternatively, the tube 60 can be attached in the groove 40 in any manner.

The groove 40 and the tube 60 are designed here such that the tube 60 protrudes radially beyond the circumferential face 42 with a protrusion U and thus forms an abutment face.

In an alternative embodiment, the tube 60 may not extend radially beyond the circumferential face 42 and can, for example, radially abut the circumferential face 42.

In the sense of the invention, the tube 60 also radially closes the coolant channel 30 in the portion 32 of the groove 40 when the tube 60 is arranged within the groove 40. In other words, in the portion 32 of the groove 40, the interior 72 of the tube 60 forms the coolant channel 30, thereby reliably sealing it, in particular such that no coolant exits the groove 40 in the coolant-cooled cutting operation.

In this case, the tube 60 extends with one end 66 in the axial direction beyond the groove 40 and into the first axial portion 31 of the coolant channel 30, whereby the tube 60 is additionally attached in the first axial portion 31 in the radial direction in a positively locking manner.

Analogously, with an opposite end 68 in the axial direction, the tube 60 extends beyond the groove 40 and into the third axial portion 33 of the coolant channel 30, whereby the tube 60 is additionally attached in the third axial portion 31 in the radial direction in a positively locking manner.

In this context, the first axial portion 31 has an inner diameter that corresponds to the outer diameter D of the tube 60 in order to ensure a tight transition for the coolant.

Of course, the third axial portion 31 can also have an inner diameter corresponding to the outer diameter D of the tube 60.

In this way, the tube 60 is longer in the axial direction than the groove 40 and is attached with both ends 66, 68 outside of the groove 40.

Thus, in an alternative embodiment, the tube 60 can be attached exclusively outside of the groove 40 in the coolant channel 30.

Furthermore, the tool body 12 in the cutting portion 22 comprises a second coolant channel 70 (see FIG. 6) through which the coolant channel 30 is fluidly connected to the opening 37.

The second coolant channel 70 opens into the coolant channel 30 at a point where the tube 60 extends over the mouth of the second coolant channel 70.

To fluidly connect the interior 72 (see FIG. 8) of the tube 60 to the second coolant channel 70, the tube 60 has a lateral opening (not shown) arranged opposite the mouth in the tube wall 74.

In this manner, during the cutting operation, coolant can flow through the coolant terminal 34 via the coolant channel 30 and through the openings 36, 37 into the cutting region 38. Here, in the portion 32 with the groove 40, the coolant flows through the interior 72 of the tube 60.

In order to manufacture the rotary cutting tool 10, by contrast to the embodiment shown in FIGS. 1 to 4, the groove 40 is not welded but rather closed with the tube 60.

For this purpose, the tube 60 is first inserted with the ends 66, 68 into the first and third axial portions 31, 33 of the coolant channel 30, respectively, and then pushed laterally into the groove 40 in the radial direction.

The lateral openings in the tube wall 74 are formed in the tube 60 after the tube 60 has been inserted into the coolant channel 30, for example together with the drilling of the second coolant channel 70.

In this way, a rotary cutting tool 10 is provided which can be manufactured with low effort, in particular by means of the described method.

Furthermore, rotary cutting tools 10 having a large axial length and/or a large diameter can be manufactured with low effort.

In particular, it is not necessary to twist the tool body 12 during manufacture in order to create helical coolant channels 30.

The invention is not limited to the embodiments shown. Individual features of one embodiment can in particular be combined as desired with features of other embodiments, in particular independently of the other features of the corresponding embodiments.

1. A rotary cutting tool having an axis of rotation and a tool body extending along the axis of rotation and having at least one coolant channel, characterized in that at least a portion of the at least one coolant channel is formed by a groove in a circumferential face of the tool body, wherein the at least one coolant channel is closed in the portion of the groove in the radial direction by an add-on part of the rotary cutting tool, which is attached to the tool body.

2. The rotary cutting tool according to claim 1, characterized in that the at least one coolant channel is arranged in a fluted portion of the tool body having at least one flute.

3. The rotary cutting tool according to claim 2, characterized in that the at least one coolant channel and the at least one flute extend helically in the axial direction.

4. The rotary cutting tool according to claim 1, characterized in that the groove has a cross-section with at least one straight segment.

5. The rotary cutting tool according to claim 2, characterized in that the groove has a cross-section with at least one straight segment.

6. The rotary cutting tool according to claim 3, characterized in that the groove has a cross-section with at least one straight segment.

7. The rotary cutting tool according to claim 1, characterized in that the add-on part is formed by a tube that is attached in the at least one coolant channel.

8. The rotary cutting tool according to claim 2, characterized in that the add-on part is formed by a tube that is attached in the at least one coolant channel.

9. The rotary cutting tool according to claim 3, characterized in that the add-on part is formed by a tube that is attached in the at least one coolant channel.

10. The rotary cutting tool according to claim 4, characterized in that the add-on part is formed by a tube that is attached in the at least one coolant channel.

11. The rotary cutting tool according to claim 7, characterized in that the tube radially abuts or projects beyond the circumferential face of the tool body.

12. The rotary cutting tool according to claim 7, characterized in that the tube comprises a tube wall with an opening that fluidly connects the interior of the tube laterally to a second coolant channel of the rotary cutting tool, in particular wherein the second coolant channel is formed in a portion axially opposite a shaft-side portion of the rotary cutting tool.

13. The rotary cutting tool according to claim 11, characterized in that the tube comprises a tube wall with an opening that fluidly connects the interior of the tube laterally to a second coolant channel of the rotary cutting tool, in particular wherein the second coolant channel is formed in a portion axially opposite a shaft-side portion of the rotary cutting tool.

14. The rotary cutting tool according to claim 1, characterized in that the add-on part is formed by a weld seam.

15. The rotary cutting tool according to claim 2, characterized in that the add-on part is formed by a weld seam.

16. The rotary cutting tool according to claim 3, characterized in that the add-on part is formed by a weld seam.

17. The rotary cutting tool according to claim 4, characterized in that the add-on part is formed by a weld seam.

18. A method for manufacturing a rotary cutting tool according to claim 1, with the steps of:
a) manufacturing the at least one coolant channel by means of machining, and
b) attaching the add-on part.

19. The method according to claim 18, characterized in that the groove of the at least one coolant channel is formed in the circumferential face of the tool body in the radial direction.
